(19) United States
(12) Patent Application Publication
(10) Pub. No.: US 2014/0173463 A1
(43) Pub. Date: Jun. 19, 2014

(54) system and method for providing a user interface element presence indication during a video conferencing session

(71) Applicants: April Slayden Mitchell, San Jose, CA (US); Ian N. Robinson, Pebble Beach, CA (US)

(72) Inventors: April Slayden Mitchell, San Jose, CA (US); Ian N. Robinson, Pebble Beach, CA (US)

(21) Appl. No.: 14/235,894

(22) PCT Filed: Jul. 29, 2011
(86) PCT No.: PCT/US2011/046020

§ 371 Date: Jan. 29, 2014

(51) Int. Cl. H04L 29/06

(52) U.S. Cl. CPC H04L 65/403
USPC 715/753

(57) ABSTRACT

The user interface element presence indication control component 102 comprising: a user interface presence indication component 106a-n for providing user interface information to n sites (110a-n) participating in a video conferencing session wherein the n sites (110a-110n) include a display (120a-120n) for displaying video and content, wherein for each remote site sharing the user interface element, the user interface element is displayed at each of the remote sharing sites, wherein for each of the remote sites that are not sharing the user interface element, a corresponding user interface element presence indicator 132a-n is displayed at each of the remote non-sharing sites.

### BACKGROUND

Some desktop sharing solutions have the feature of only sharing content after the host expressly enables the function of sharing the content. Examples of the content shared are: sharing their entire desktop, sharing an area of the desktop or sharing a specific application on the desktop. When using desktop sharing software during a video sharing session, certain user interface elements (Le., the open and closing of dialogs, selecting a different pen color via the toolbar) may not presented to all video conferencing sites. For video sessions where gestures can be seen, the remote sites can see the gesture but not the user interface element.

### BRIEF DESCRIPTION OF DRAWINGS

The figures depict implementations/embodiments of the invention and not the invention itself. Some embodiments are described, by way of example, with respect to the following Figures.

FIG. 1 illustrates a block diagram of a user interface element presence indication control system for preserving interface interaction awareness in a video conferencing session displayed on a through-the-screen display according to an example of the invention;

FIG. 2A shows a front view of a video conferencing participant interacting with a user interface element at a first site, where the user interface element is not displayed on the through-the-screen display from the perspective of a participant at a second site;

FIG. 2B shows a front view of a video conferencing participant interacting with a user interface element at a first site where a corresponding presence indication element is displayed on the through-the-screen display, where the front view is from the perspective of a participant at a second site according to an example of the invention;

FIG. 3A illustrates a front view of a user interface element from the perspective of a local participant at a first local site when the user interface element presence indicator is obscuring from the perspective of the remote participant according to an example of the invention;

FIG. 3B illustrates a front view of a user interface element displayed in FIG. 3A from the perspective of a remote participant at a second remote site when the user interlace element presence indicator is obscuring according to an example of the invention;

FIG. 4A illustrates a front view of a user interface element displayed on a through-the-screen display from the perspective of a local participant at a first local site according to an example of the invention;

FIG. 4B illustrates a front view of a user interface element displayed on a through-the-screen display from the perspective of a remote participant at a second remote site where the user interface element presence indicator is mirroring the user interface element shown in FIG. 4A according to an example of the invention;

FIG. 4C illustrates a front view of a user interface element displayed on a through-the-screen display from the perspective of a remote participant at a second remote site where the user interface element presence indicator is mirroring and changing the contrast and brightness of the user interface element shown in FIG. 4A according to an example of the invention;

FIG. 4D illustrates a front view of a user interface element displayed on a through-the-screen display from the perspective of a remote participant at a second remote site where the user interface element presence indicator is mirroring and changing the contrast, brightness and blurring of the user interface element shown in FIG. 4A according to an example of the invention;

FIG. 5A illustrates a front view of a user interface element displayed on a through-the-screen display from the perspective of a local participant at a first local site when the user interface element is being shared according to an example of the invention;

FIG. 5B illustrates a front view of a user interface element displayed on a through-the-screen display from the perspective of a remote participant at a second remote site when the user interface element is being shared according to an example of the invention;

FIG. 5C illustrates a front view of a user interface element displayed on a through-the-screen display from the perspective of a remote participant at a second remote site when the user interface element is being shared according to an example of the invention;

FIG. 6 illustrates a flow diagram of a method of displaying a user interface element and it's corresponding presence indicator according to an example of the present invention;

FIG. 7 shows a computer system for implementing the method shown in FIG. 6 described in accordance with examples of the present invention.

The drawings referred to in this Brief Description should not be understood as being drawn to scale unless specifically noted.

### DETAILED DESCRIPTION OF EMBODIMENTS

For simplicity and illustrative purposes, the principles of the embodiments are described by referring mainly to examples thereof. In the following description, numerous specific details are set forth in order to provide a thorough understanding of the embodiments. It will be apparent, however, to one of ordinary skill in the art, that the embodiments may be practiced without limitation to these specific details. Also, different embodiments may be used together. In some instances, well known methods and structures have not been described in detail so as not to unnecessarily obscure the description of the embodiments.

When using desktop sharing software, certain user interface elements (i.e., such as the open and closing of dialogs, the selection of a different pen color via the toolbar, etc.) may not be presented to the remote participants. In video conferencing sessions in which the participant's gestures with respect to the shared content are conveyed, if the user interface is not displayed then the video conferencing participant interacting with the user interface element will be appear to be gesturing towards or interacting with an area of the display screen that appears blank or to have unrelated content. This scenario can be confusing and further provides incomplete information (partial communication) to the remote participants viewing the video conferencing session. To provide additional information to the remote participants, the present invention provides a system and method for providing an indication of the existence and location of a user interface element.

According to one example, each user interface element is displayed or alternatively a representation (the user interface element interaction indicator) is displayed at each video conference site. The local video conference participant can choose or choose not to share each user interface element that is on their display screen. If the participant chooses not to share the user interface element, a corresponding representation of the user interface element (the local user interface presence indicator) is displayed at the other video conferencing sites.

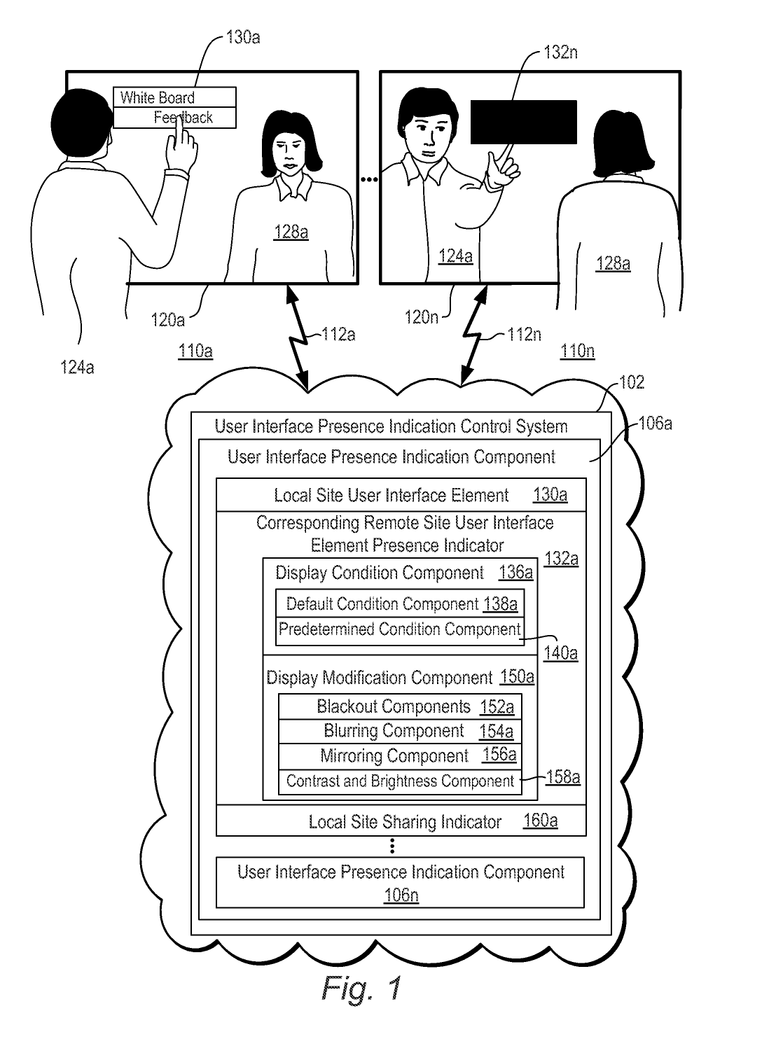

Referring to FIG. 1 shows a block diagram of a user interface element presence indication control system 102 for preserving interface interaction awareness in a video conferencing session displayed on a through-the-screen display system. The user interface element presence indication control component 102 comprising: a user interface presence indication component 106a-n for providing user interface information to n sites (110a-n) participating in a video conferencing session wherein the n sites (110a-110n) include a display (120a-120n) for displaying video and content, wherein for each remote site sharing the user interface element, the user interface element is displayed at each of the remote sharing sites, wherein for each of the remote sites that are not sharing the user interface element, a corresponding user interface element presence indicator 132a-n is displayed at each of the remote non-sharing sites.

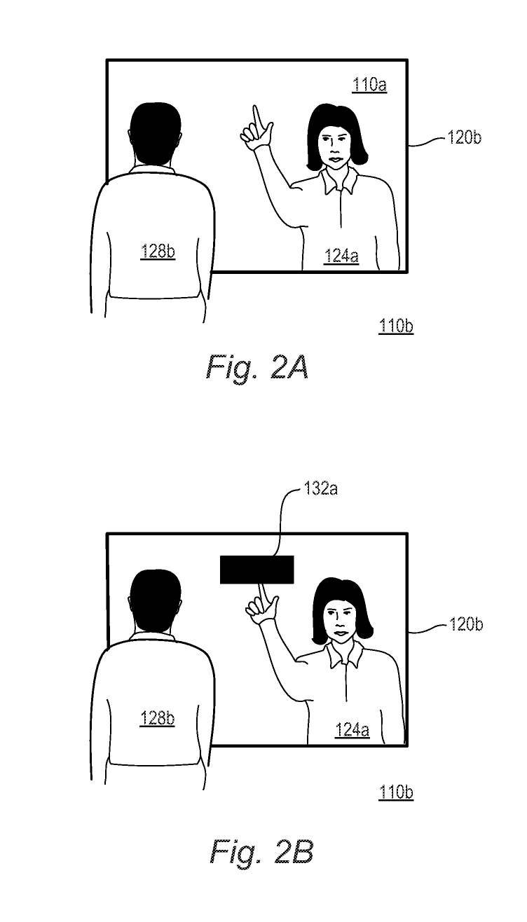

In the examples shown in FIGS. 1, 2A-B, 3A-3B, 4A-4D, and 5A-5C, the type of display system shown is a through-the-screen display system such as is described in “ConnectBoard: A remote collaboration system that supports gaze-aware interaction and sharing,” Kar-Han Tan; Robinson, I.; Samadani, R.; Bowon Lee: Gelb, D.; Vorbau, A.; Culbertson, B.; Apostolopoulos, J.; Multimedia Signal Processing, 2009. MMSP '09. IEEE International Workshop on , vol., no., pp. 1-6, 5-7 Oct. 2009. However, other types of display systems may be used. In one example, the types of display systems used should have the ability to display video and share content from other video conferencing sites on the display screen. In addition, the types of displays used should capture the video conference participant's gaze and gestures or interactions with the user interface elements displayed on the display screen.

Referring to FIG. 2A shows a front view of a video conference participant interacting with a user interface element (not shown) at a first site, where the user interface element is not displayed on the through-the-screen display 120b from the perspective of a remote participant 128b at a second site 110b. In the example shown in FIG. 2A, the system 102 (via system default conditions) or site participant 124a may choose to display or not display the user interface element. The video conferencing system shown in FIG. 2A does not support a user interface presence indicator. Thus, it appears to the other participants at the other sites, that the local participant at the first site is interacting or gesturing towards an area of the screen that has no content. This can be confusing to the other remote participants and makes it difficult for the remote participant to easily follow what and understand the actions being taken by the participant at the local site.

Referring to FIG. 2B shows a front view of a local participant 124a interacting with a user interface element at a first site where a corresponding presence indication element is displayed on the through-the-screen display. In the example shown in FIG. 2B, the view shown is from the perspective of a remote participant 128b at a second remote site 110b. The view shown in FIG. 2B is from the same video session, at the same time and perspective as the example shown in FIG. 2A, except the example shown in FIG. 2B utilizes the system and method according to the present invention where a user interface element presence indicator is utilized.

As in the example shown in FIG. 2A, the system or local participant has set the system conditions in the example shown in FIG. 2B set so that the user interface element shown is private and thus is not displayed to the remote participant at the second remote site. In the example shown in FIG. 2B, since the local site user interface element 130a is not to be shared or displayed on the display screen 120b to the remote site participant 128b, a corresponding user interface element presence interaction indicator 132a is shown. In the example shown in FIG. 2B, the user interface element presence indicator 132a is represented as a black box positioned at the same location of the user interface element 130a (not shown) at the local site 110a. This implementation provides the local site participant 124a with the privacy level desired, but at the same time it provides a more complete source of information to the participants at the other sites. Specifically, the user interface element presence indicator 132a provides an indication to the remote users that the local user is interacting with an interface and the location of the interface.

In some desktop sharing applications, actions may be hidden from the user. For example in a slide presentation, the slides are shared on the desktop exactly as the local site participant wishes the remote site viewer to see them. However, in a videoconferencing environment where video of both the participant and the content they are interacting with is combined and displayed on a single display, the remote participant's gestures, gaze and interactions with respect to the shared content are visible. For example, a remote viewer might see the local site participant navigating to a slide, selecting a slide, modifying a slide, etc. Although the local participant may or may not choose to let the remote participant see each of the user interfaces they are interacting with, it is important to let the remote user know that the local participant is interacting with some user interface. Otherwise, the remote viewer may be confused by the local participant's interactions, Further, if the user interface element is not shared, it is important that the participants be able to distinguish between user interface elements that are local and those user interface elements that are remote. Otherwise, the remote participant may think that they can interact with local user interfaces (user interfaces controlled by the local video conferencing only) if the local user interfaces are indistinguishable from those the remote participant would normally see on their own display.

Referring to FIG. 1 shows a user interface element presence indication control system 102. In one example, user interface element presence indication control system and method is used in a multi-way (n-way) video conferencing session. The system 102 is communicatively coupled 112a-n to the displays at the multiple sites 110a-n. The system 102 receives input and outputs information used in determining and providing a user interface element and the corresponding user interface element presence indicator to be displayed to a plurality of display devices 120a-n. The system shown is described with respect to n displays 120a-n, where n is an integer value greater than one. In the implementation shown in FIG. 1, n is equal to two.

Referring to the example in FIG. 1 shows views of two sites 110a and 110n that are participating in a video conferencing session. Site 110a is from the viewpoint of a local participant interacting with a user interface element. When the term local participant is used it is with respect to the participant who is able to view and control the user interface element. Thus in FIG. 1, the local participant 124a can view and interact with/control the user interface element 130a. In FIG. 1, site 110n is shown from the viewpoint of the remote participant 128a. The remote participant 128a cannot interact with/control the user interface element 130a. Instead of seeing the user interface element 130a, the remote participant 128a sees the corresponding user interface element presence indicator 132n.

Referring to FIG. 1, the corresponding remote site presence indicator 132a includes a display condition component 136a-n for determining the conditions under which the user interface element presence indicator is displayed and whether the display conditions have been met. In one example, the display condition component 136a includes a default condition component 138a and a predetermined condition component 140a. In one example of the invention, every user interface element that appears on the display of the local and remote participants either displays the user interface element or an indication of the user interface presence indication element.

In one example, the default condition component 136a or predetermined condition component 140a can be set either by the local participant or alternatively by the system or the system administrator. For example, for the condition where there is a user interface where a password is being entered, the system default 136a for the user interface might be to obscure the password entry by displaying a black box user interface element presence indicator which would black out or obscure the local participant's password.

In another example, there may be predefined conditions entered by the system or user which determine when the user interface might be displayed. For example, the system may include a teaching mode, wherein when the local user is teaching a class where they wish to share a password which will give the participants in the video conference (the class) temporary access to the software program being taught. For this case, the predetermined condition might be whether the local site participant is in the teaching mode.

The conditions under which the user interface elements are displayed or a user interface element presence indicator is displayed may be set for individual user interface elements displayed on the screen, a subset of all the user elements displayed or all of the user elements displayed. Thus, dependent upon the default set for the display of each interface element presence indicator, all of the user interface elements may be displayed, or the local user may display one user interface element and hide another user interface element dependent upon the default display settings. Thus the system provides the ability to display some user interface elements while hiding other user interface elements. This provides the participants more control over the individual interface elements with regards to what user interface elements are displayed and what user interface elements are not displayed.

Similarly, the conditions which the user interface elements are displayed or a user interface element presence indictor is displayed may be set for a particular to a single site, a subset of the sites participating in the video conferencing session, or all of the sites participating in the video conferencing session. For example, in one example a subset of the sites may be paying for a higher end video conferencing solution and have access to (see displayed) user interface elements that participants paying for a lower end video conferencing solution service do not see displayed. In this case, the subset of sites paying the lower price may see displayed a blacked out box or other presence indicator that substantially obscures the user interface while the subset of sites paying the higher price sees the user interface element, Alternatively, the subset of sites paying the higher price may see a user interface element presence indicator that provides a higher level of communication regarding the user interface. For example, the subset of sites paying the higher price may see a user interface element presence indicator that mirrors the local participant's user interface element which provides increased information compared to seeing the blacked out box that the lower paying participants see.

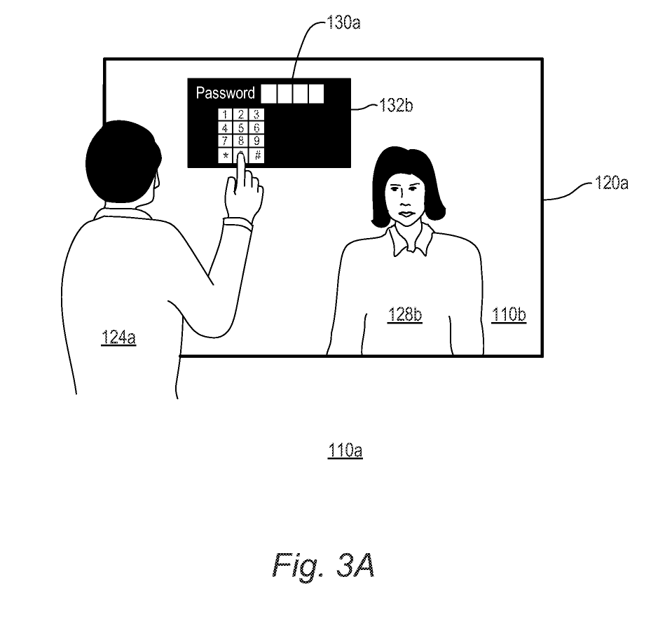

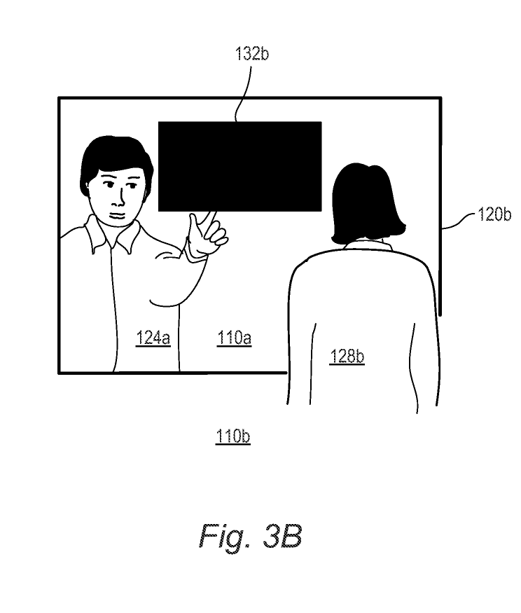

Either the system or the user can set predefined default conditions under which the user interface element or the user interface presence indication element is shown. For example, for the case of a password entry, the system or local user can set as a default condition that the user interface presence indication element will be shown to avoid sharing the local user's private password. In addition, to provide complete security the default setting might be to provide a completely obscuring black box such as shown in FIGS. 3A and 3B.

Either the system or the user can set predefined default conditions under which the user interface element or the user interface presence indication element is shown. For example, for the case of a password entry, the system or local user can set as a default condition that the user interface presence indication element will be shown to avoid sharing the local user's private password. In addition, to provide complete security the default setting might be to provide a completely obscuring black box such as shown in FIGS. 3A and 3B.

Referring to FIG. 1, the corresponding remote site presence indicator 132a includes a display modification component 150a-n. In one example of the invention, for user interface elements that are not shared, every user interface element that appears on the display of the local and remote participants either displays (1) the user interface element or (2) a representation of the user interface presence indication element. In one example, the user interface element presence indicator is a modified representation of the user interface element, In one example, the user interlace element presence indicator is a representation at a remote site that corresponds to the physical location of the original user interface element on the display in a modified form. How the user interface element may be modified to provide a representative user interface element presence indicator is controlled by the display modification component 150a-n. In one example, the display modification component includes: a blackout component 152a-n, a blurring component 154a-n, a contrast and brightness adjustment component 158a-n, and a mirroring component 156a-. Other types of modifications may be made to provide a representation of the user interface element. The modifications listed 152a-n, 154a-n, 156a-n and 158a n-n are listed only for purposes of example.

FIG. 3A illustrates a front view of a user interface element 130a from the perspective of a local participant 124a at a first local site 110a when the user interface element presence indicator 132a is obscuring from the perspective of the remote participant 128b according to an example of the invention. FIG. 3B illustrates a front view of a user interface element displayed in FIG. 3A from the perspective of a remote participant 128b at a second site 110b when the user interface element presence indicator 132b is obscuring the user interface elemen according to an example of the invention.

The embodiment shown in FIG. 3A shows an example of a user interface element 130a used by a local participant 124a for entering a password. Since in the example shown, the local participant 124a wishes to block the remote participant 128b from viewing the entry of their password, the local participant and/or system, has set the system controls so that the remote participant cannot view the local participant's user interface. Because it would not be desirable for the remote participant to see the local participant interacting with an invisible interface (blank screen), instead, the remote participant views an obscuring rectangular black box 132b. Thus, the remote participant can only see the black rectangular obscuring box and not the local participant's password. When blended over the remote party's video, this commonly viewed interface preserves the natural method for two parties interacting on opposite sides of the display surface.

Although the representation (user interface element presence indicator) could be the same for each user interface element element (I,.e. a black obscuring box), in one example the user interface element presence indicator corresponds to the original user interface element in both its location on the display screen and it's physical size. Thus, for example, the user interface element presence indicator 132n shown in FIG. 1 corresponds to the physical size and physical location of the user interface element 130a. Similarly, in example shown in FIG. 3A, the corresponding user interface element presence indicator is a black opaque rectangular box located in the physical vicinity of the user interface element.

In the embodiment shown in FIGS. 3A and 3B, although the location of the user interface element 130a is approximately in the same physical location as the user element presence indicator 132b, in one example the size and shape of the user interface element presence indicator is different. Specifically, in the embodiment shown in FIGS. 3A and 3B, the boundaries or perimeter of the obscuring black box 132b extend past the actual user interface element 130a. Although this rectangular shape is not a requirement, in this implementation extending past the boundaries of the actual user interface provides additional information to the local participant entering his or her password. The black box implementation provides the information that the user interface element is being displayed to the remote site, but that the sharing of the information displayed on the user interface element is blacked out or obscured.

There are various ways to provide an indication to the local participant that the user interface element may be being viewed by another participant at another site. For example, as previously stated the boundaries of the user interface element presence indicator could extend past the boundaries of the user interface element providing a visual cue to the local participant regarding the existence of a user interface element presence indicator. In another example, we could demonstrate to the local site and the remote site that something is visible to another site by changing its opacity. In an alternative example, the user interface element could be revealed but could be otherwise modified. For example, the user interface element could glow a green shade on the local participant's side when the remote participants could not view the local participant's interface and glow red when the remote participants could view the local participant's user interface element.

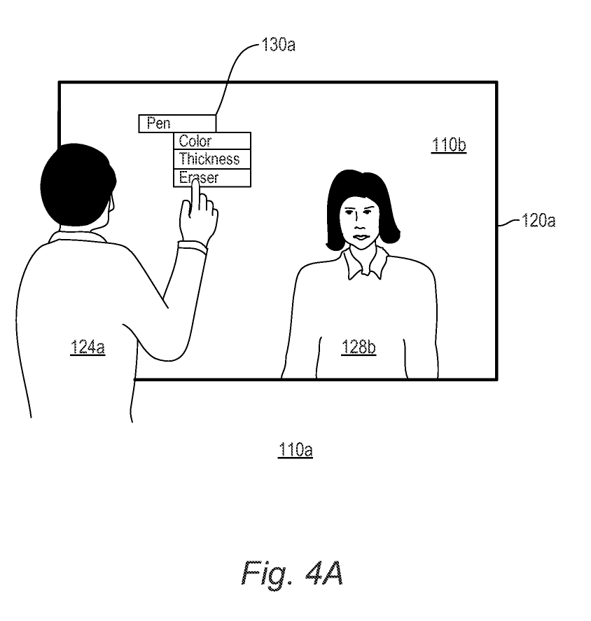

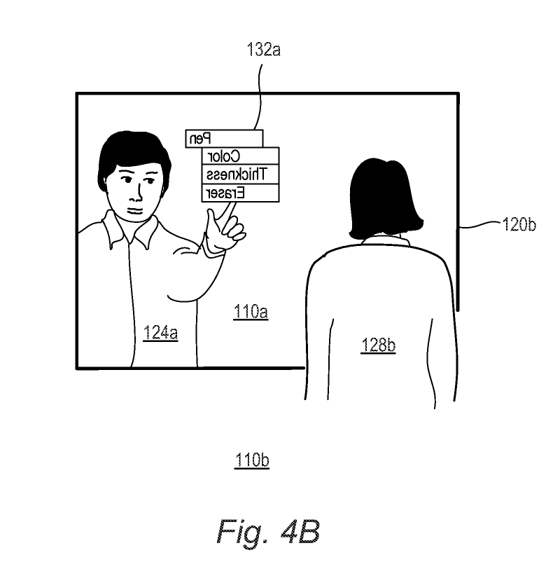

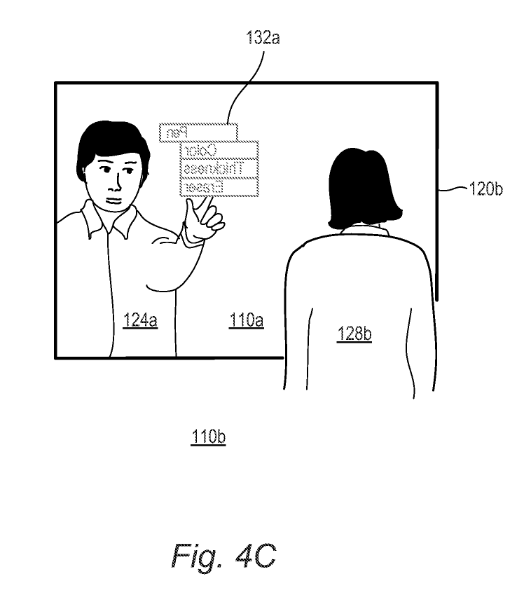

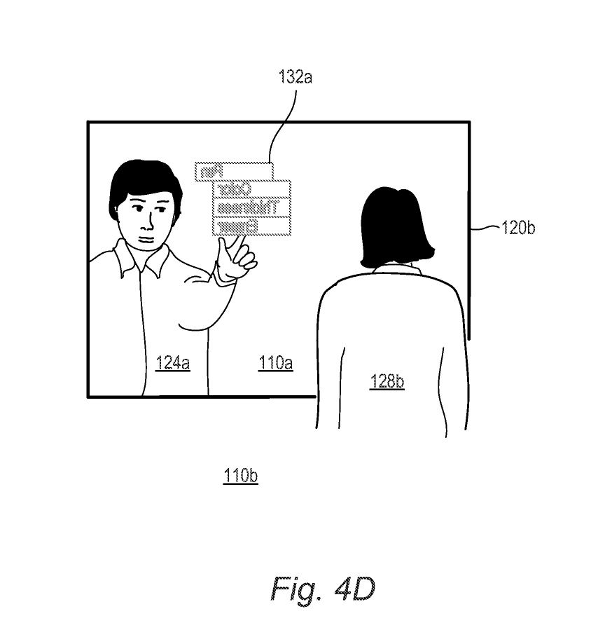

FIG. 4A illustrates a front view of a user interface element displayed on a through-the-screen display from the perspective of a local participant 124a at a first local site 110a according to an example of the invention. Similar to the examples shown in FIGS. 1, 2B, 3A-3B, the local participant is interacting with the user interface element 130a while a remote participant 128b at another site 110b is viewing the interaction. In the examples shown in FIGS. 1, 2B and 3A-3B, the user element interface presence indicator is represented as an obscuring black out box. However, instead of providing a corresponding representation 132b by creating a blackout or obscuring shape—in the example shown in FIG. 4B, the user interface element presence indicator created is a mirrored image of the user interface element 130a.

Referring to FIG. 4B shows a front view of a user interface element displayed on a through-the-screen display from the perspective of a remote participant 128b at a second remote site 110b where the user interface element presence indicator 132a is mirroring the user interface element 130a shown in FIG. 4A according to an example of the invention. In contrast to the examples shown in FIGS. 1, 2B, 3A-3B where the actual content displayed on user interface element is obscured from the perspective of other remote participants, in the example shown in FIG. 4B the user interface is not trying to hide what the local participant is interacting with. The mirrored image provides information that indicates to the remote participant what the local participant is interacting with while at the same time providing an indication (backwards mirrored lettering) that the user interface element is on the other side of the display. The backwards mirroring conveys to the remote participant an indication that the user interface element is something that remote participant can view but not likely interact with or control.

Referring to FIG. 4C illustrates a front view of a user interface element displayed on a through-the-screen display from the perspective of a remote participant 128b at a second remote site 110b where the user interface element presence indicator 132a is mirroring and changing the contrast and brightness of the user interface element shown in FIG. 4A according to an example of the invention. Similar to the embodiment shown in FIG. 4B, the user interface element presence indicator is mirrored. However, in addition to being mirrored the contrast and brightness of the user interface element is modified via the contrast and brightness module 158a of the display modification component. Although the contrast and brightness module can modify either the contrast or brightness, in the example shown in FIG. 4C both the contrast and brightness of the mirrored user interface element shown in FIG. 4B were modified to lessen the contrast and increase the brightness of the displayed interface. This provides further indication to the remote participant that the interface displayed is on the other side of the display.

FIG. 4D illustrates a front view of a user interface element displayed on a through-the-screen display from the perspective of a remote participant 128b at a second remote site 110b where the user interface element presence indicator 132a is mirroring and changing the contrast, brightness and blurring of the user interface element shown in FIG. 4A according to an example of the invention. Similar to the embodiment shown in FIG. 4C, the user interface element presence indicator is mirrored and has diminished contrast and brightness compared to the original user interface element displayed in FIG. 4A. However, in addition to being mirrored and having diminished contrast and brightness, the user interface element is modified via the blurring module 156a of the display modification component 140a, The blurred image is meant to provide an indication of distance—that the user interface element presence indicator is further away—providing further indication to the remote participant that the interface displayed is on the other side of the display.

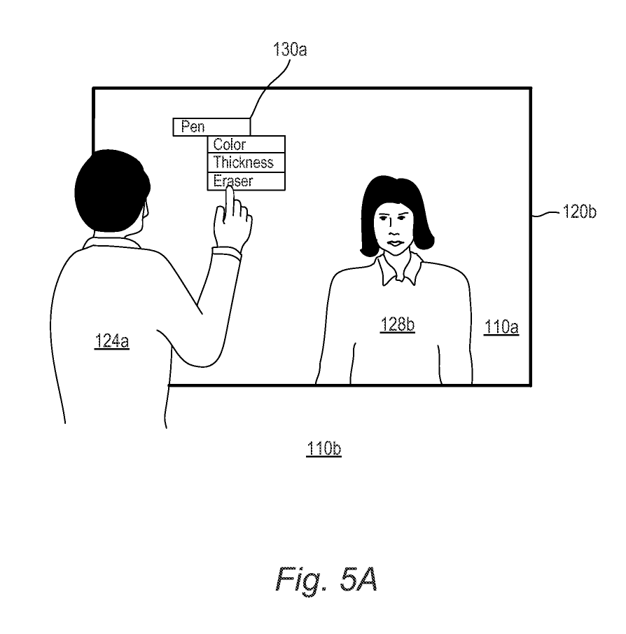

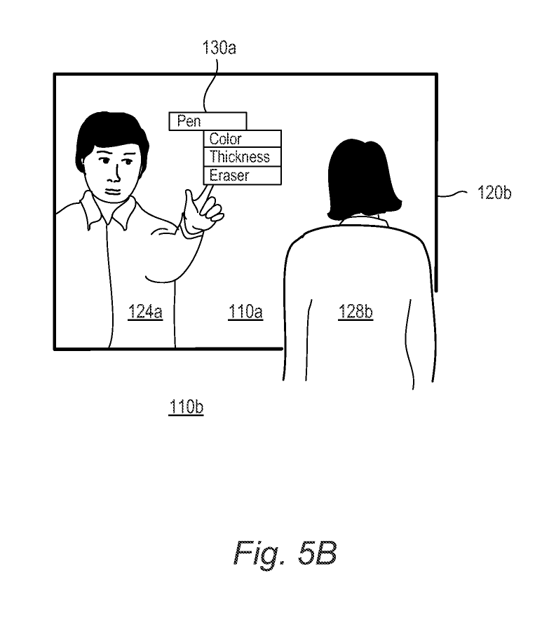

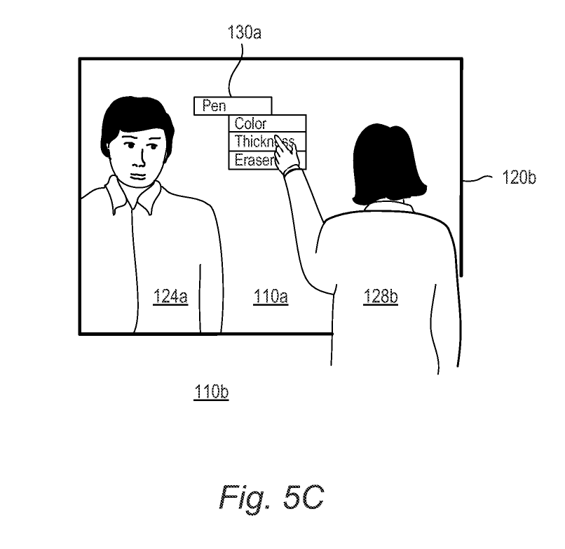

FIG. 5A illustrates a front view of a user interface element displayed on a through-the-screen display from the perspective of a local participant 124a at a first local site 110a when the user interface element 130a is being shared according to an example of the invention. By “shared” we mean that the participants of the video conference have access and the ability to control the user interface element shown. Referring to FIG. 5A shows a local participant 124a interacting with the user interface element—a menu for choosing pen options for writing on a shared whiteboard on the display shown.

FIG. 5B illustrates a front view of a user interface element displayed on a through-the-screen display from the perspective of a remote user at a second remote site when the user interface element is being shared according to an example of the invention. In one example, the shared user interface shown from the perspective of the local participant is identical to the shared user interface from the perspective of the remote participant in FIG. 5B. Thus both participant 124a and participant 128b see the same user interface element. Whether the two user interfaces are seen are shared is determined by the Local Site Sharing Indicator 160a.

Although in FIG. 5B, participant 124a is shown interacting with the user interface, any of the participant in the video conference at shared sites (sites where the user interface is shared) can interact with and control the user interface element. For example using the user interface element, one participant could choose a color of a pen that they wish to use to write with on the shared content whiteboard while another participant at a different site (a sharing site) uses the same user interface to choose the thickness of the pen used to write on the shared content whiteboard.

Because the user interlace element is shared, both participants can interact with the user interface element. FIG. 5C illustrates a front view of a user interface element displayed on a through-the-screen display from the perspective of a participant 128b at a second remote site 110b. In the example shown in FIG. 5C, the participant 128b is the local participant (the person interacting with and controlling the user interface element.) As previously stated, in the example shown in FIG. 5C, the participants at the other at least a subset of sites that are sharing the user interface element, see the same user interface element. In the example shown in FIG. 5C, the participant 128b is selecting the thickness feature on the user interface to change the thickness of the pen used to write on the shared whiteboard.

In one example, there is an indication to the participant at the site that the user interface element is available for sharing. In one example, there is an indication to the participant at the site that the user interface element is being shared with other sites. In one example (not shown) there could be a text box with the word “sharing” near the user interface element to indicate that the user interface element is being shared. In another example (not shown), the user interface element could glow green to indicate that it is acceptable for either participant to interact with the user interface element.

In one example, the user interface indication system does not support sharing of the user interface element. In this case, the local site sharing indicator 160a may be eliminated. In addition, steps 610a and 620 may be eliminated. For this case the user interface indication display controller 102 is comprised of: a user interface indication component 106 for providing user interface information to at least a first site 110a and a second site 110b participating in a video conferencing session, wherein the at least first and second sites (110a, 110b) include a display (120a, 120b) for displaying video and shared content, wherein each of the user interface elements 130a-n at each of the sites 110a-n participating in the video conferencing session has a corresponding user interface element presence indicator 132a-n, wherein either the user interface element 130a-n or its corresponding user interface element presence indicator 132a-n is displayed at each of the video conference sites.

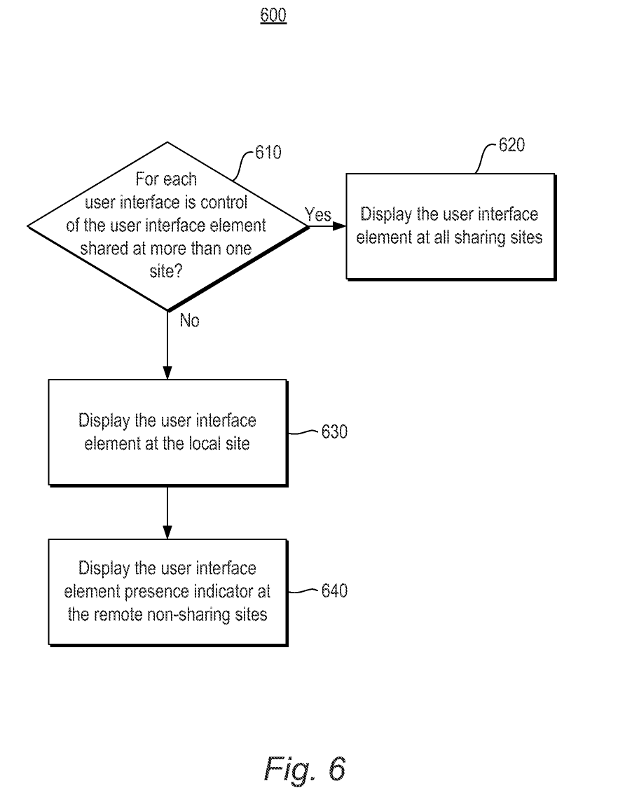

FIG. 6 illustrates a flow diagram of a method 600 of displaying a user interface element and it's corresponding presence indicator according to an example of the present invention. Referring to FIG. 6, in one example each the user interface elements are first checked to see if the user interface elements are shared at more than one site participating in the video conferencing session (step 610). If the user interface elements are shared, then the user interface element is displayed at all of the sites (step 620) that are designated as sharing the user interfaces. If the user interface elements are not shared, then the user interface element is displayed at the local site (step 630). For the other non-sharing sites, the user interface element presence indicator is displayed.

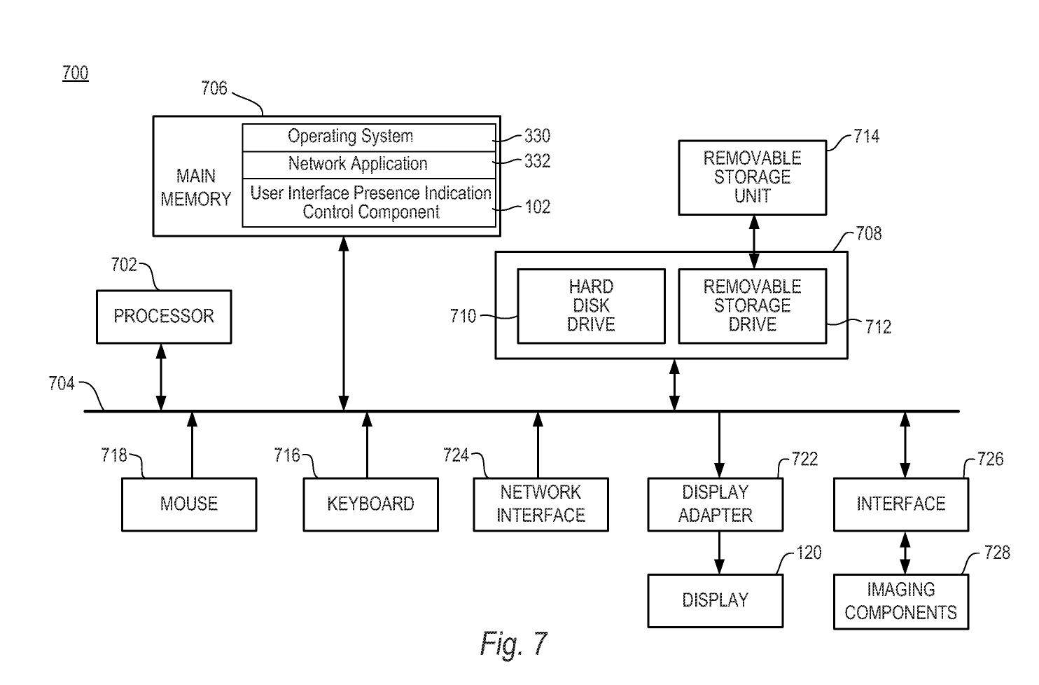

FIG. 7 shows a computer system for displaying a user interface element and it's corresponding presence indicator according to the method shown in FIG. 6. FIG. 7 shows a computer system for implementing the user interface indication display controller 102 described in FIGS. 1, 2A-B, 3A-D and 4A-B, 5A-5C and 6 described in accordance with examples of the present invention. It should be apparent to those of ordinary skill in the art that the method 600 represents generalized illustrations and that other steps may be added or existing steps may be removed, modified or rearranged without departing from the scopes of the method 600. The descriptions of the method 600 are made with reference to the system 102 illustrated in FIG. 1 and thus refers to the elements cited therein. It should, however, be understood that the method 600 is not limited to the elements set forth in the system 100. Instead, it should be understood that the method 600 may be practiced by a system having a different configuration than that set forth in the system 102.

Some or all of the operations set forth in the method 600 may be contained as utilities, programs or subprograms, in any desired computer accessible medium. In addition, the method 600 may be embodied by computer programs, which may exist in a variety of forms both active and inactive. For example, they may exist as software program(s) comprised of program instructions in source code, object code, executable code or other formats. Any of the above may be embodied on a computer readable medium, which include storage devices and signals, in compressed or uncompressed form.

FIG. 7 illustrates a block diagram of a computing apparatus 700 configured to implement or execute the methods 600 depicted in FIG. 6 and described in accordance with examples of the present invention. In this respect, the user interface indication component 106 may be used as a platform for executing one or more of the functions described hereinabove.

The computing apparatus 700 includes one or more processor(s) 702 that may implement or execute some or all of the steps described in the methods 500. Commands and data from the processor 702 are communicated over a communication bus 704. The computing apparatus 700 also includes a main memory 706, such as a random access memory (RAM), where the program code for the processor 702, may be executed during runtime, and a secondary memory 708. The secondary memory 708 includes, for example, one or more hard drives 710 and/or a removable storage drive 712, representing a removable flash memory card, etc., where a copy of the program code for the method 400 may be stored.

The removable storage drive 712 reads from and/or writes to a removable storage unit 714 in a well-known manner.

These methods, functions and other steps may be embodied as machine readable instructions stored on one or more computer readable mediums, which may be non-transitory. Exemplary non-transitory computer readable storage devices that may be used to implement the present invention include but are not limited to conventional computer system RAM, ROM. EPROM, EEPROM and magnetic or optical disks or tapes. Concrete examples of the foregoing include distribution of the programs on a CD ROM or via Internet download. In a sense, the Internet itself is a computer readable medium. The same is true of computer networks in general. It is therefore to be understood that any electronic device and/or system capable of executing the functions of the above-described examples are encompassed by the present invention.

Although shown stored on main memory 706, any of the memory components described 706, 708, 714 may also store an operating system 730, such as Mac OS, MS Windows, Unix, WebOS or Linux; network applications 732; and a balance control component 734. The operating system 730 may be multi-participant, multiprocessing, multitasking, multithreading, real-time and the like. The operating system 730 may also perform basic tasks such as recognizing input from input devices, such as a keyboard or a keypad; sending output to the display 720; controlling peripheral devices, such as disk drives, printers, image capture device; and managing traffic on the one or more buses 704. The network applications 732 includes various components for establishing and maintaining network connections, such as software for implementing communication protocols including TCP/IP, HTTP, Ethernet, USB, and FireWire.

The computing apparatus 700 may also include an input devices 716, such as a keyboard, a keypad, functional keys, etc., a pointing device, such as a tracking ball, cursors, etc., and a display(s) 720, such as the LCD screen display 122 shown for example in FIG. 1. A display adaptor 722 may interface with the communication bus 704 and the display 720 and may receive display data from the processor 702 and convert the display data into display commands for the display 720.

The processor(s) 702 may communicate over a network, for instance, a cellular network, the Internet, LAN, etc., through one or more network interfaces 724 such as a Local Area Network LAN, a wireless 802.11x LAN, a 3G mobile WAN or a WiMax WAN. In addition, an interface 726 may be used to receive an image or sequence of images from imaging components 728 such as the image capture device.

The foregoing description, for purposes of explanation, used specific nomenclature to provide a thorough understanding of the invention. However, it will be apparent to one skilled in the art that the specific details are not required in order to practice the invention. The foregoing descriptions of specific examples of the present invention are presented for purposes of illustration and description. They are not intended to be exhaustive of or to limit the invention to the precise forms disclosed. Obviously, many modifications and variations are possible in view of the above teachings. The examples are shown and described in order to best explain the principles of the invention and its practical applications, to thereby enable others skilled in the art to best utilize the invention and various embodiments with various modifications as are suited to the particular use contemplated. It is intended that the scope of the invention be defined by the following claims and their equivalents:

What is claimed is:

1. The user interface element presence indication control component 102 comprising:
a user interface presence indication component 106a-n for providing user interface information to n sites (110a-n) participating in a video conferencing session wherein the n sites (110a-110n) include a display (120a-120n) for displaying video and content,
wherein for each remote site sharing the user interface element, the user interface element is displayed at each of the remote sharing sites,
wherein for each of the remote sites that are not sharing the user interface element, a corresponding user interface element presence indicator 132a-n is displayed at each of the remote non-sharing sites.

2. The system recited in claim 1 further including an indication to the participants that the user interface element is being shared.

3. The system recited in claim 1 further wherein the user interface element presence indicator is a modified version of the user interface element.

4. The system recited in claim 1 wherein the user interface element presence indicator is at the same relative physical location on the display screen for the remote and local participants.

5. The system recited in claim 1 wherein the user interface element presence indicator on remote sites obscures the user interface element on the local site.

6. A method of providing an indication of the presence of a user interface element including the steps of:
determining for each user interface element, whether a user interface element is shared at more than one sites of n sites (step 610) participating in a video conferencing session, wherein each of the n sites includes a display for displaying video and content,
wherein for each remote site sharing the user interface element, the user interface element is displayed at each of the remote sharing sites (step 620),
wherein for each of the remote sites that are not sharing the user interface element , a corresponding user element presence indicator is displayed at each of the remote non-sharing remote sites (step 640).

7. The method recited in claim 6 further including the step of providing an indication to the participants that the user interface element is being shared.

8. The method recited in claim 6 further including the step of modifying the user interface element to generate a user interface element presence indicator .

9. The method recited in claim 6 further including the step of displaying the user interface element presence indicator at the same physical location on the display screen for the remote and local participants.

10. The method recited in claim 6 wherein the user interface element presence indicator on remote sites obscures the user interface element on the local site.

11. A non-transitory computer readable medium having computer readable instructions stored thereon for causing a computer system to perform instructions, comprising the steps of:
determining for each user interface element, whether a user interface element is shared at more than one sites of n sites (step 610) participating in a video conferencing session, wherein each of the n sites includes a display for displaying video and content,
wherein for each remote site sharing the user interface element, the user interface element is displayed at each of the remote sharing sites,
wherein for each of the remote sites that are not sharing the user interface element , a corresponding user element presence indicator is displayed at each of the remote non-sharing remote sites.

12. The computer readable medium recited in claim 11 further including the step of providing an indication to the participants that the user interface element is being shared.

13. The computer readable medium recited in claim 11 further including the step of modifying the user interface element to generate a user interface element presence indicator.

14. The computer readable medium recited in claim 11 further including the step of displaying the user interface element presence indicator at the same physical location on the display screen for the remote and local participants.

15. The computer readable medium recited in claim 11 wherein the user interface element presence indicator on remote sites obscures the user interface element on the local site.
